(19) United States
(12) Patent Application Publication
(10) Pub. No.: US 2004/0080503 A1
(43) Pub. Date: Apr. 29, 2004

(54) LCD driver power saving during evaluation

(75) Inventors: Kevin Jones, Swindon (GB); Julian Tyrrell, Cricklade (GB)

Correspondence Address: GEORGE O. SAILE & ASSOCIATES, 28 DAVIS AVENUE, POUGHKEEPSIE, NY, 12603, US

(73) Assignee: Dialog Semiconductor GmbH.

(21) Appl. No.: 10/290,129

(22) Filed: Nov. 7, 2002

(30) Foreign Application Priority Data
Oct. 24, 2002 (EP) 02368116.6

(51) Int. Cl. G09G 5/00; G09G 3/36

(52) U.S. Cl. 345/211; 345/87

(57) ABSTRACT

This invention provides a method and an apparatus for saving power dissipation during the testing and evaluation of liquid crystal display LCD panels. In addition, this invention provides a method and apparatus of the changing of the order of backplane and segment addressing to reduce the power consumed by LCD panels. The method includes the step of interlacing the access of common or backplane addresses to an LCD. The LCD power saving method also includes the interlacing the access of the RAM data driving the LCD segment drivers. The segment address signals are developed from data read out of a random access memory, RAM. The segment address signals are activated such that alternating LCD panel locations are written with ones and zeros in a checkerboard pattern so as to stress the LCD panel in the worst case. This method provides for the saving of power dissipation during testing and evaluation by reducing the amount of segment switching from once every backplane cycle to once every frame.

### BACKGROUND OF THE INVENTION

1. Field of the Invention

This invention relates to a method and an apparatus for saving power dissipation during the testing and evaluation of liquid crystal display LCD panels.

More particularly this invention relates to the changing of the order of backplane and segment addressing to reduce the power consumed by LCD panels.

2. Description of Related Art

Currently, liquid crystal display LCD panels are evaluated by using a checkerboard pattern displayed on the LCD panel as a worst case. This checkerboard panel display represents the worst case example for LCD panel power dissipation. The checkerboard pattern of LCD panel data 470 is shown in FIG. 4. The ones value is denoted by an ‘X’ in the LCD cell location 410. A zero value is illustrated with a blank square cell area 420 in FIG. 4. The LCD panel shown in FIG. 4 is an 8 by 8 matrix. There are 8 common or backplane addresses shown such as 430 which is an odd common address. An even common or ‘com’ address is also highlighted 440. FIG. 4 shows the com address 450. The com address line selects which row of the matrix in FIG. 4 is selected for writing to or reading from. FIG. 4 also shows the segment address 460. The segment address would select which column of the LCD panel is being written to or read from. A uniquely selected LCD panel cell is selecting by activating the combination of the appropriate segment address and com address in FIG. 4. For example, cell 420 in FIG. 4 is selected for writing to or reading from by activating com line 1 and segment line 2.

FIG. 1 shows a conventional prior art block diagram of an LCD panel display subsystem. The LCD panel 160 has segment addresses, Seg0, Seg1, Seg2, . . . Seg_n 110. These addresses are from the data output of a random access memory 140. An address control block 150 produces the read address 120 to the RAM as well as the Common or backplane connections Com0, Com1, Com2, . . . Com_n 130. As we showed in the previous discussion on FIG. 4, the segment address selects the row of the LCD panel matrix while the Com lines select the column of the LCD panel matrix.

FIG. 2 illustrates the timing diagram for the conventional RAM. The common backplane signals Com0, Com1, Com2, and Com3 210, 220.230. 240 occur sequentially every period. The timing diagram of the segment population is shown in FIG. 2. The column of the matrix is selected when the segment lines are low as we see 250, 290 in FIG. 2. During Com0 time 210, the even columns of the LCD matrix are selected via Seg0 and Seg 2—250, 290. During Com1 time 220, the odd columns of the LCD matrix are selected via Seg1 and Seg 3—270, 285. During Com2 time, the even columns of the LCD matrix are selected via Seg0 and Seg 2—260, 275. During Com3 time 240, the odd columns of the LCD matrix are selected via Seg1 and Seg 3—280, 295.

U.S. Pat. No. 6,172,661 (Imajo, et al.) “Low power driving method for reducing non-display area of TFT-LCD” describes a low power driving method for reducing non-display area of a thin film transistor liquid crystal display.

U.S. Pat. No. 6,275,209 (Yamamoto) “LCD driver” describes a liquid crystal display driver.

U.S. Pat. No. 6,137,465 (Sekine, et al.) “Drive circuit for a LCD device” discloses a drive circuit for a liquid crystal display device.

### BRIEF SUMMARY OF THE INVENTION

It is the objective of this invention to provide a method and an apparatus for saving power dissipation during the testing and evaluation of liquid crystal display. LCD panels.

It is further an object of this invention to the changing of the order of backplane and segment addressing to reduce the power consumed by LCD panels.

The objects of this invention are achieved by a method that saves power consumption during the testing and evaluation of LCDs. The method includes the step of interlacing the access of common or backplane addresses to an LCD. The LCD power saving method also includes the interlacing the access of the RAM data driving the LCD segment drivers. The LCD power saving method continues with the presenting a common or backplane address to the LCD panel which selects the even common or backplane LCD drivers as a group in time sequence. The common or backplane signals are developed from an address control logic block. The common or backplane LCD addresses are activated in a time order of com0 first, com1 second, com2 third and com3 fourth. The com0, com1, com2 and com3 signals are each active for a period of time, which is the inverse of the frequency required to refresh, said LCD panel. The method also includes the presenting of a common or backplane address to the LCD panel which selects the odd common or backplane LCD drivers as a group in time sequence. The segment address signals are developed from data read out of a random access memory, RAM. The segment address signals are activated such that alternating LCD panel locations are written with ones and zeros in a checkerboard pattern so as to stress the LCD panel in the worst case. This method provides for the saving of power dissipation during testing and evaluation by reducing the amount of segment switching from once every backplane cycle to once every frame.

The LCD power saving method also saves power consumption during normal operation as well as during testing and evaluation by either interlacing the access of the common or backplane addresses or non-interlacing the access of the common or backplane addresses. This method of saving power during normal mode requires the selecting of either interlace or non-interlace modes depending on the content of the LCD display data. This normal mode LCD power saving method includes user selection of either interlace or non-interlace modes. This user selection is controlled by a programmable circuit, which senses the content of said display data.

### BRIEF DESCRIPTION OF THE DRAWINGS

FIG. 1 shows a block diagram of an LCD panel system which helps to explain both the prior art and this invention.

FIG. 2 gives a timing diagram of a prior art LCD panel system.

FIG. 3 gives a timing diagram of the LCD panel system of this invention.

FIG. 4 illustrates the checkerboard data pattern that is used to test LCD panels.

FIG. 5a illustrates the prior art checkerboard data pattern.

FIG. 5b illustrates the prior art non-interlace control signals for LCD panels.

FIG. 6a illustrates a prior art checkerboard data pattern for testing the LCD.

FIG. 6b illustrates the interlace timing diagram for the main embodiment of this invention.

### DETAILED DESCRIPTION OF THE INVENTION

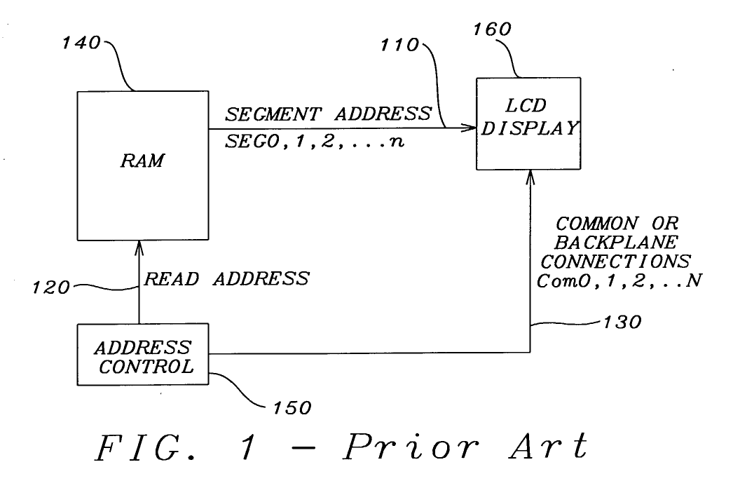

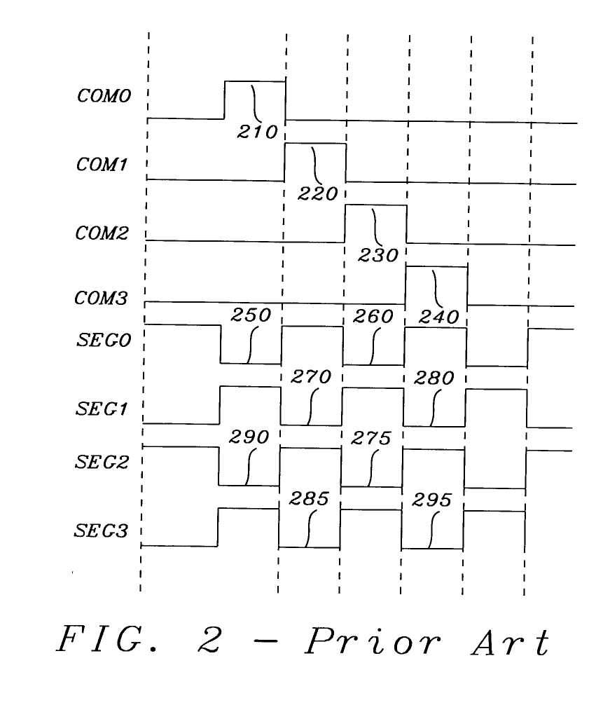

As described previously in the prior art section, FIG. 1 shows the block diagram for the reading and writing of LCD panels. The segment address, Seg0-n (110) selects which columns of the LCD panel 160 are being accessed for reading or writing. The common or backplane address connections, Com0-3 (130) determine which row of the LCD panel is accessed. These addresses are from the data output of a random access memory 140. An address control block 150 produces the read address 120 to the RAM as well as the Common or backplane connections Com0, Com1, Com2, . . . Com_n (130).

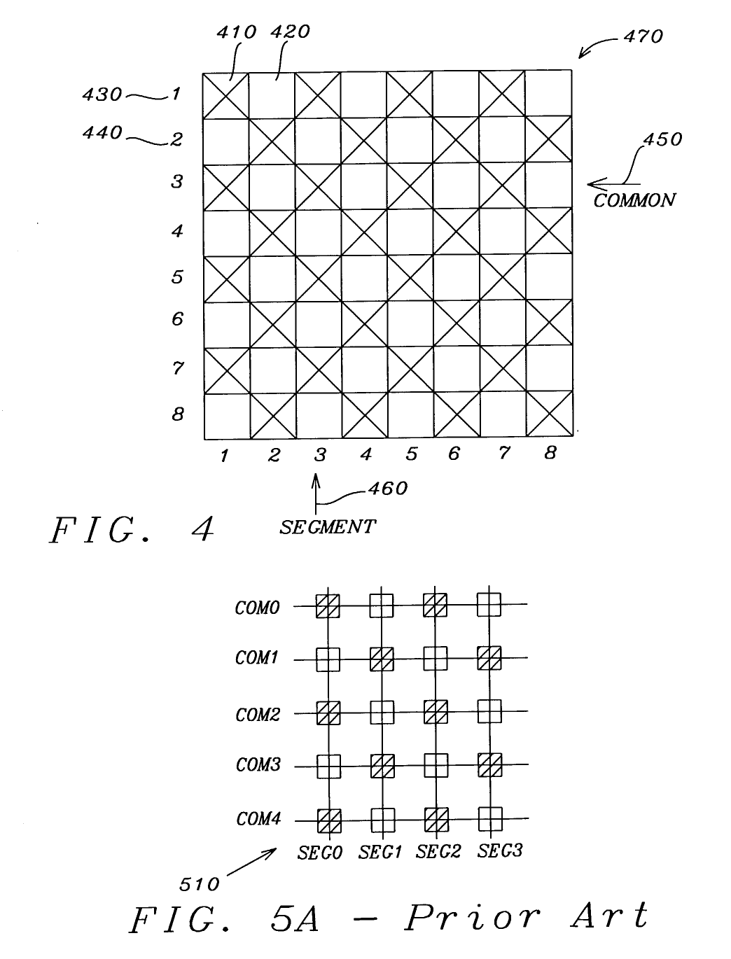

FIG. 4 illustrates an 8 by 8 LCD panel matrix. The LCD panel 470 in FIG. 4 is loaded with a checkerboard pattern of alternating ones and zeros, which ‘X’ denotes a one is stored. There are 8 common or backplane addresses shown such as 430 which is an odd common address. An even common or ‘com’ address is also highlighted 440. FIG. 4 shows the com address 450. The com address line selects which row of the matrix in FIG. 4 is selected for writing to or reading from. FIG. 4 also shows the segment address 460. The segment address would select which column of the LCD panel is being written to or read from. A uniquely selected LCD panel cell is selecting by activating the combination of the appropriate segment address and com address in FIG. 4. For example, cell 420 in FIG. 4 is selected for writing to or reading from by activating com line 1 and segment line 2.

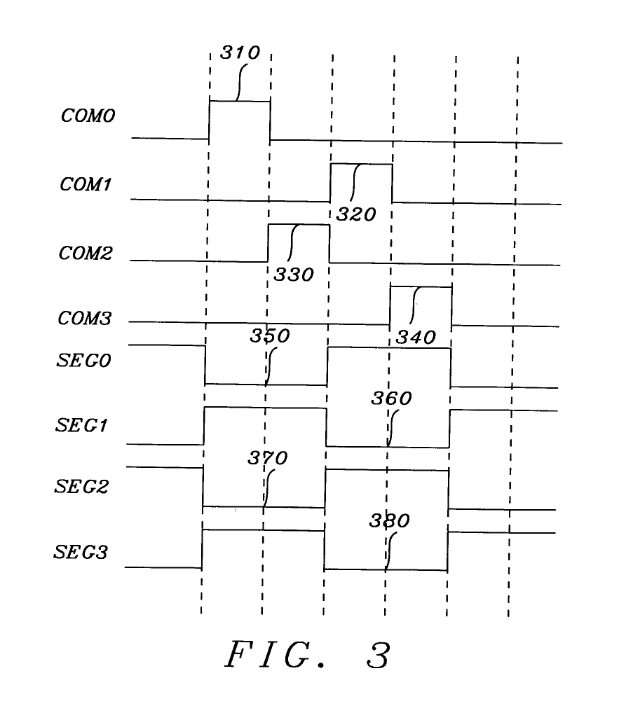

FIG. 3 illustrates the timing diagram for the main embodiment of this invention. The common backplane signals Com0, Com1, Com2, and Com3 310, 320,330, 340 occur as shown in FIG. 3. The timing diagram of the segment signals is shown in FIG. 3. The column of the matrix is selected when the segment lines are low as we see 350, 370 in FIG. 3. During Com0 310 and Com1 time 330, the even columns of the LCD matrix are selected via Seg0 and Seg 2—350, 370. During Com1 time 320 and Com3 time 340, the odd columns of the LCD matrix are selected via Seg1 and Seg 3—360, 380.

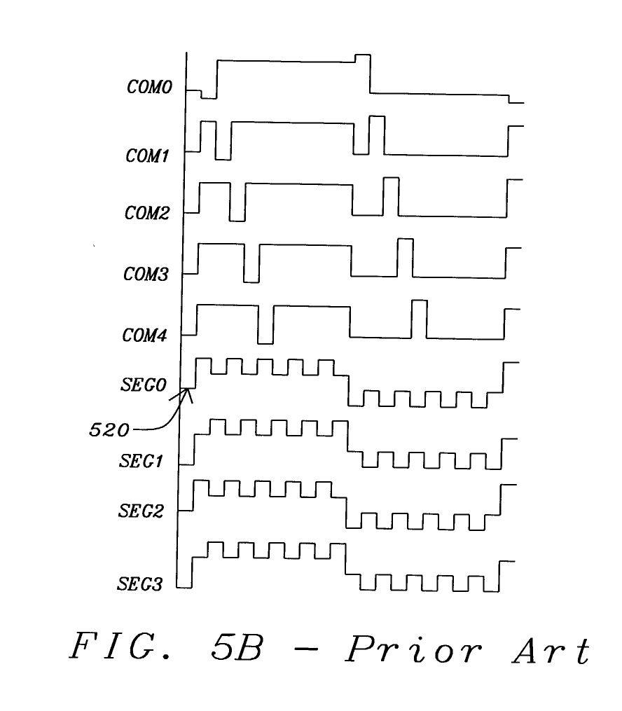

FIG. 5 shows the prior art case of traditional non-interlaced LCD panel accessing. FIG. 5 gives the checkerboard data pattern loaded into the LCD panel 510.

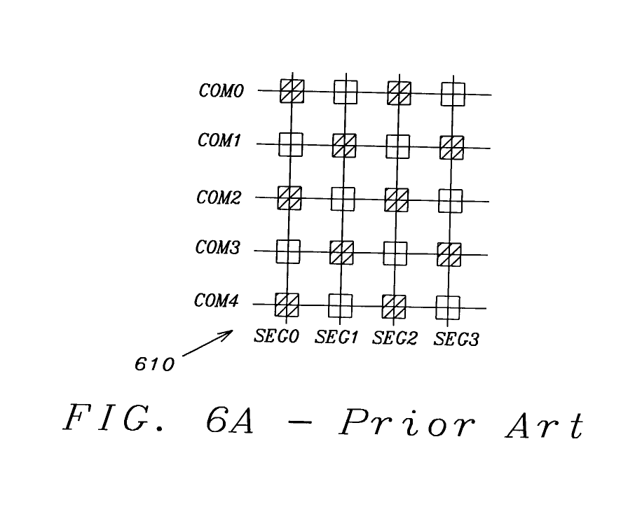

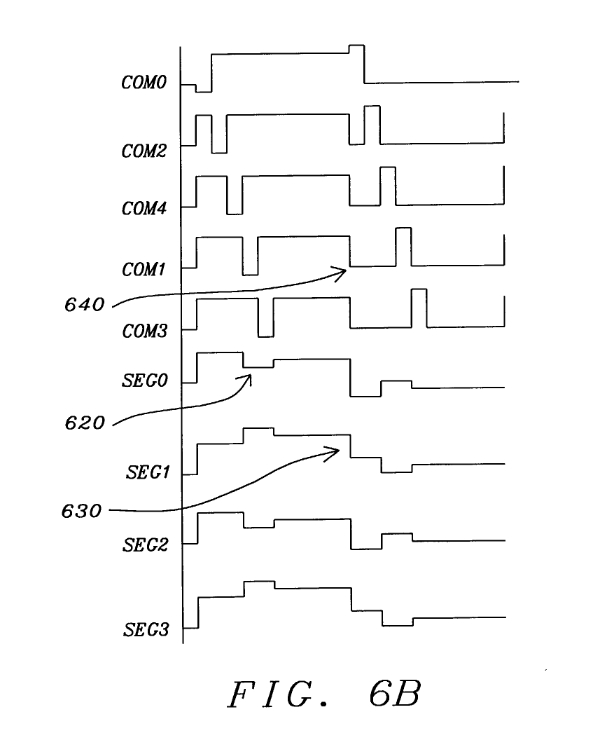

FIG. 6b shows the timing diagram of the main embodiment of this invention of the new case of interlaced LCD panel accessing. FIG. 6a gives the checkerboard data pattern loaded into the LCD panel 610.

The advantage of this LCD panel testing invention is the reduction of the total current, Idd drawn, in checkerboard testing mode. This is accomplished by reducing the amount of segment switching from once every backplane cycle to once every once every frame. As seen in FIG. 5, with the prior art non-interlace method the segment switches every backplane cycle 520. As seen in FIG. 6b, with the new interlace method the segment switches every frame 620. In addition, FIG. 6b shows the essence of the interlaced mechanism of this invention. On the plot of Seg1 in FIG. 6b, the transition from even to odd scan 630 shows that the operation of the segment lines is inverted during the odd frame, which follows the even frame. The segment line is inverted during the odd frame 630, which follows the even frame. Similarly, the Com signals are inverted during the odd frame which follows the even frame. Another advantage is the the principles of this invention in the testing and evaluating of LCD panels can be used during normal LCD panel operation in the field. This normal mode operation depends on the LCD data patterns.

While this invention has been particularly shown and described with Reference to the preferred embodiments thereof, it will be understood by those Skilled in the art that various changes in form and details may be made without Departing from the spirit and scope of this invention.

What is claimed is:

1. An LCD, liquid crystal display, driver power saving method which saves power consumption during the testing and evaluation of LCDs comprising the steps of:
interlacing the access of common or backplane addresses to a LCD.

2. The LCD power saving method of claim 1 further comprising the step of:
interlacing the access of RAM data driving the LCD segment drivers.

3. The LCD power saving method of claim 1 further comprising the step of:
presenting a common or backplane address to the LCD panel which selects the even common or backplane LCD drivers as a group in time sequence.

4. The LCD power saving method of claim 3 wherein common or backplane signals are developed from an address control logic block.

5. The LCD power saving method of claim 3 wherein said common or backplane LCD address is activated in a time order of a first address bit, a second address bit, a third address bit and a fourth address bit.

6. The LCD power saving method of claim 5 wherein said com0, com1, com2 and com3 signals are each active for a period of time which is the inverse of the frequency required to refresh said LCD panel.

7. The LCD power saving method of claim 1 further comprising the step of:
presenting a common or backplane address to the LCD panel which selects the odd common or backplane LCD drivers as a group in time sequence.

8. The LCD power saving method of claim 7 wherein segment address signals are developed from data read out of a random access memory, RAM.

9. The LCD power saving method of claim 7 wherein said segment address signals are activated such that alternating LCD panel locations are written with ones and zeros in a checkerboard pattern so as to stress the LCD panel in the worst case.

10. The LCD power saving method of claim 1 wherein power dissipation is saved during testing and evaluation by reducing the amount of segment switching from once every backplane cycle to once every frame.

11. An LCD power saving method which saves power consumption during normal operation of the LCD panel comprising the steps of:
providing an interlacing mode to the access of the common or backplane addresses, and
providing a non-interlacing mode to the access of the common or backplane addresses.

12. The LCD power saving method of claim 11 further comprising the step of:
selecting of said interlace or non-interlace modes depending on the content of the display data.

13. The LCD power saving method of claim 12 wherein said user selection of said interlace or non-interlace modes is controlled by a programmable circuit which senses the content of said display data.

14. An LCD, liquid crystal display, driver power saving apparatus which saves power consumption during the testing and evaluation of LCDs comprising the means for:
interlacing the access of common or backplane addresses to a LCD.

15. The LCD power saving apparatus of claim 14 further comprising the means for:
interlacing the access of the RAM data driving the LCD segment drivers.

16. The LCD power saving apparatus of claim 14 further comprising the means for:
presenting a common or backplane address to the LCD panel which selects the even common or backplane LCD drivers as a group in time sequence.

17. The LCD power saving apparatus of claim 16 wherein common or backplane signals are developed from an address control logic block.

18. The LCD power saving apparatus of claim 16 wherein said common or backplane LCD addresses are activated in a time order of com0 first, com1 second, com2 third and com3 fourth.

19. The LCD power saving apparatus of claim 18 wherein said com0, com1, com2 and com3 signals are each active for a period of time which is the inverse of the frequency required to refresh said LCD panel.

20. The LCD power saving apparatus of claim 14 further comprising the means for:
presenting a common or backplane address to the LCD panel which selects the odd common or backplane LCD drivers as a group in time sequence.

21. The LCD power saving apparatus of claim 20 wherein the segment address signals are developed from data read out of a random access memory, RAM.

22. The LCD power saving apparatus of claim 20 wherein said segment address signals are activated such that alternating LCD panel locations are written with ones and zeros in a checkerboard pattern so as to stress the LCD panel in the worst case.

23. The LCD power saving apparatus of claim 14 wherein power dissipation is saved during testing and evaluation by reducing the amount of segment switching from once every backplane cycle to once every frame.

24. An LCD power saving apparatus which saves power consumption during normal operation of the LCD panel comprising the steps of:
providing an interlacing mode to access of the common or backplane addresses, and
providing a non-interlacing mode to access of the common or backplane addresses.

25. The LCD power saving apparatus of claim 24 further comprising a means for:
selecting of said interlace or non-interlace modes depending on the content of the display data.

26. The LCD power saving apparatus of claim 25 wherein said user selection of said interlace or non-interlace modes is controlled by a programmable circuit which senses the content of said display data
